(19) United States
(12) Patent Application Publication
(10) Pub. No.: US 2025/0083097 A1
(43) Pub. Date: Mar. 13, 2025

(54) Apparatus and Method for Clean Power Generation from Atmospheric Carbon Dioxide

(71) Applicant: Evapco, Inc., Taneytown, MD (US)

(72) Inventors: John C. Calkins, Severna Park, MD (US); Mark Huber, Sykesville, MD (US)

(21) Appl. No.: 18/885,123

(22) Filed: Sep. 13, 2024

Related U.S. Application Data
(60) Provisional application No. 63/582,267, filed on Sep. 13, 2023.

(51) Int. Cl. B01D 53/14; C25B 1/02; F02C 3/22

(52) U.S. Cl. CPC B01D 53/1493; B01D 53/1425; C25B 1/02; F02C 3/22; B01D 2257/504

(57) ABSTRACT

A method and system for capturing carbon dioxide from the air with a carbon contactor (also referred as to a carbon capture device), using an carbonate lean/poor alkaline solution to produce a carbonate rich alkaline rich solution, sending the resulting carbonate rich solution to an electrolyzer to generate hydrogen gas, and using the hydrogen gas to power a power plant, the hydrogen gas either used alone, or blended with natural gas or ammonia, and at least some of the power generated by the power plant is used to power the contactor and the electrolyzer.

### FIELD OF THE INVENTION

This invention relates to clean air and clean power generation.

### SUMMARY OF THE INVENTION

This invention reduces greenhouse gases by removing carbon dioxide from the air using recycled hydroxide solution and generates clean power using hydrogen generated from the hydroxide solution recycling process.

A source of carbon dioxide-rich gas is provided to a reaction device or “contactor” where it is reacted with an alkaline solution, for example, sodium and/or potassium hydroxide, and thereby converted to a carbonate rich alkaline solution. Examples of representative contactors are described in U.S. Pat. No. 11,504,667, US2020/0230548 and US2022/0184553, the entirety of each of which is incorporated herein by reference. The carbonate rich alkaline solution is provided to an electrolyzer which generates hydrogen, carbon dioxide, oxygen, and a carbonate lean alkaline solution. See, by way of non-limiting examples, U.S. Pat. No. 4,337,126, and US2022/0176311, the entirety of each of which is incorporated herein by reference. The terms carbonate rich alkaline solution and carbonate lean alkaline solution are used herein to refer to the carbonate content of the solutions relative only to one-another. That is, the carbonate rich alkaline solution refers to an alkaline solution having a carbonate concentration greater than the carbonate concentration of the carbonate lean alkaline solution. The oxygen and carbon dioxide may be released to the atmosphere or collected/stored for further use/processing. The regenerated carbonate lean alkaline solution is returned to the contactor. Hydrogen generated by the electrolyzer is fed to a gas turbine power plant, either alone or together with a natural gas or ammonia feed, depending on the nature of the power plant. In a first embodiment, the hydrogen gas provided to the power plant is blended with a natural gas feed from a natural gas source. The power plant provides power to the contactor and the electrolyzer and optionally to the power grid. In a second embodiment, in addition to the hydrogen gas, an ammonia stream is provided to an ammonia-fired gas turbine power plant. According to the second embodiment the ammonia fed to the ammonia-fired gas turbine power plant may be generated using the Haber-Bosch process by an ammonia production unit from hydrogen from the electrolyzer and a separate source of nitrogen gas. In a third embodiment, the hydrogen generated by the electrolyzer is fed to a hydrogen powered gas turbine power plant. As with the first embodiment, the second and third embodiments provide power to the contactor, the electrolyzer, and the power grid. In the case of the second embodiment, the power generated may also provide power to the ammonia production unit.

### BRIEF DESCRIPTION OF DRAWINGS

FIG. 1 is an illustration of a power generation system according to an embodiment of the invention.

FIG. 2 is an illustration of a power generation system according to another embodiment of the invention.

FIG. 3 is a cross-sectional side view of a carbon capture tower according to a first embodiment of the invention.

FIG. 4 is a cross-sectional front view of a carbon capture tower according to the embodiment shown in FIG. 1.

FIG. 5 is a schematic plan view of a carbon capture tower according to a second embodiment of the invention.

FIG. 6 is a cross-section elevation view of a carbon capture tower according to the embodiment of FIG. 5.

FIG. 7 is an endwall elevation view of a carbon capture tower according to the embodiment of FIGS. 5 and 6.

FIG. 8 is a schematic plan view of a carbon capture tower according to a third embodiment of the invention.

FIG. 9 is a cross section elevation view of a carbon capture tower according to the embodiment of FIG. 8.

FIG. 10 is an endwall elevation view of a carbon capture tower according to the embodiment of FIGS. 8 and 9.

FIG. 11 is a cross-section elevation view of a carbon capture tower according to a fourth embodiment of the invention.

FIG. 12 is a cross-section elevation view of a carbon capture tower according to a fifth embodiment of the invention.

FIG. 13 is a representative plan view of the embodiment shown in FIG. 12.

FIG. 14 is a representation of an electrolyzer according to an embodiment of the invention.

FIG. 15 is a representation of a different electrolyzer according to an embodiment of the invention.

### DETAILED DESCRIPTION OF THE INVENTION

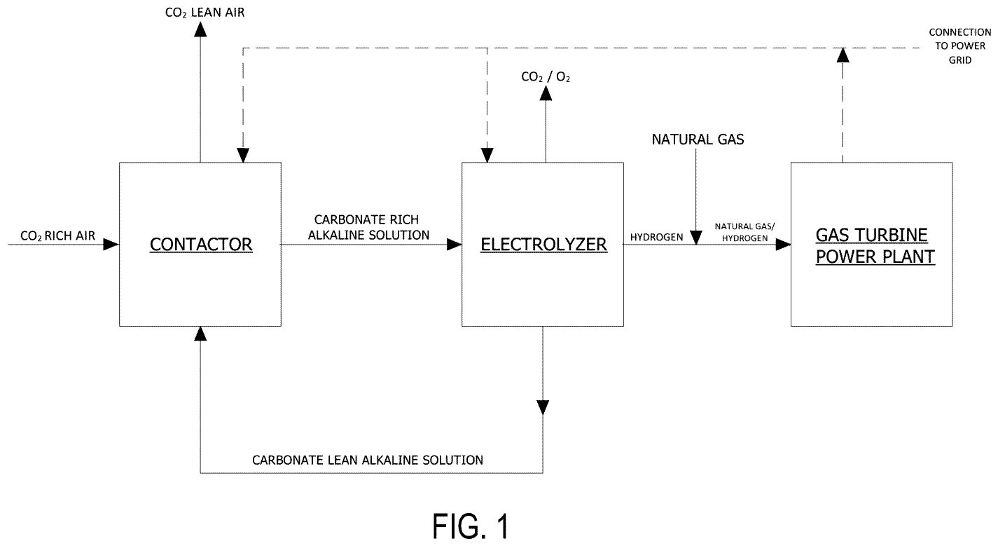

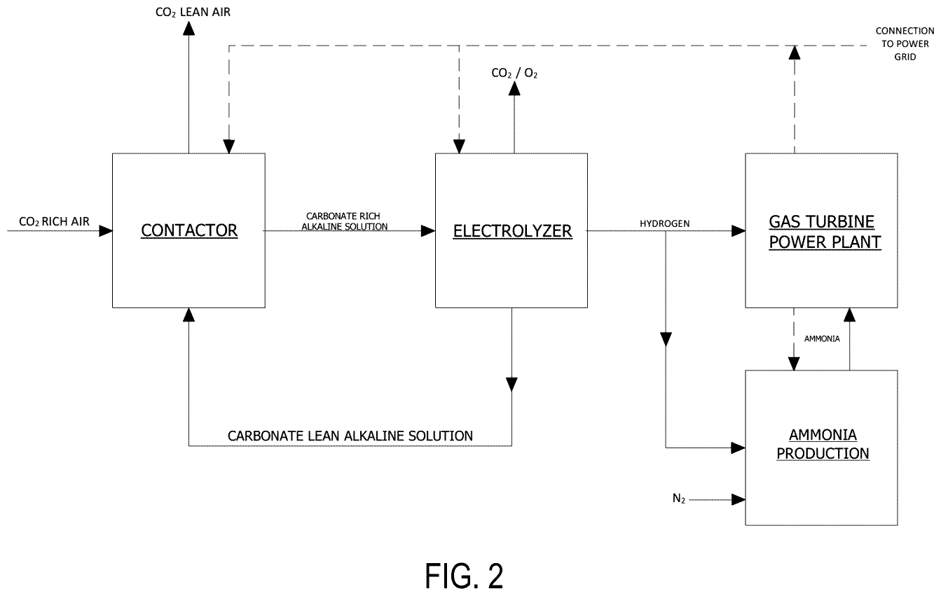

Referring to FIGS. 1 and 2, the present invention captures carbon dioxide from the air with a carbon contactor (also referred as to a carbon capture device) by reacting the carbon dioxide with a carbonate lean alkaline solution to produce a carbonate rich alkaline solution, sends the resulting carbonate rich solution to an electrolyzer to generate hydrogen gas, and uses the hydrogen gas to power a power plant, the hydrogen gas either used alone, or blended with natural gas or ammonia, and at least some of the power generated by the power plant is used to power the contactor and the electrolyzer. The electrolyzer also regenerates/recycles the carbonate rich alkaline solution into a carbonate lean alkaline solution, which is then returned to the contactor for continued reaction with atmospheric carbon dioxide to produce carbonate rich alkaline solution.

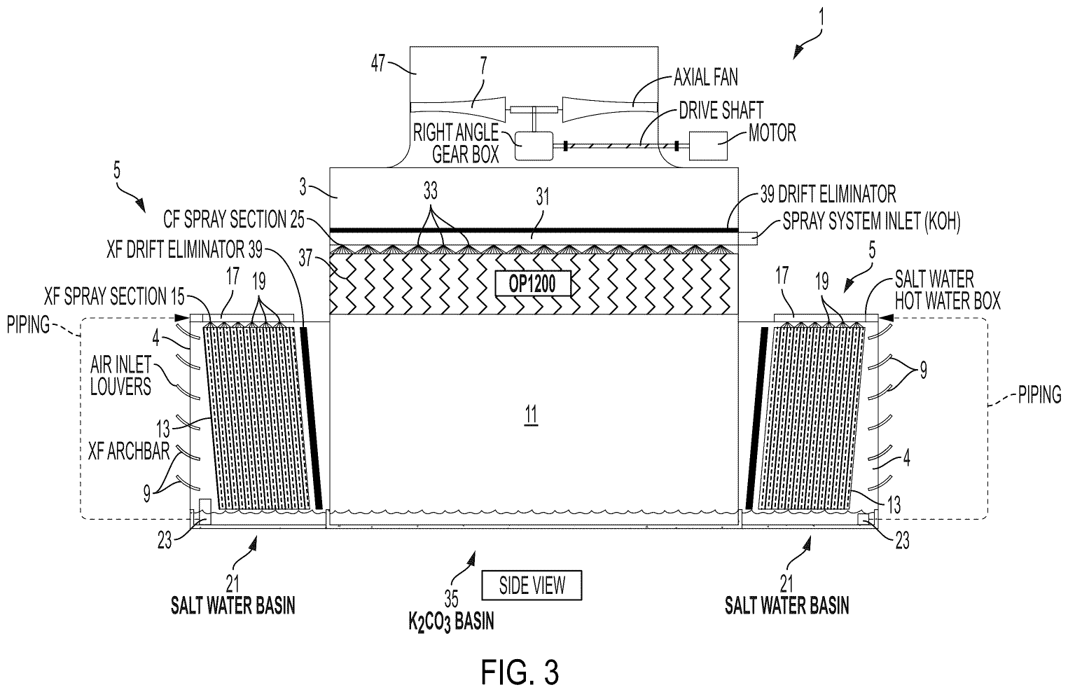

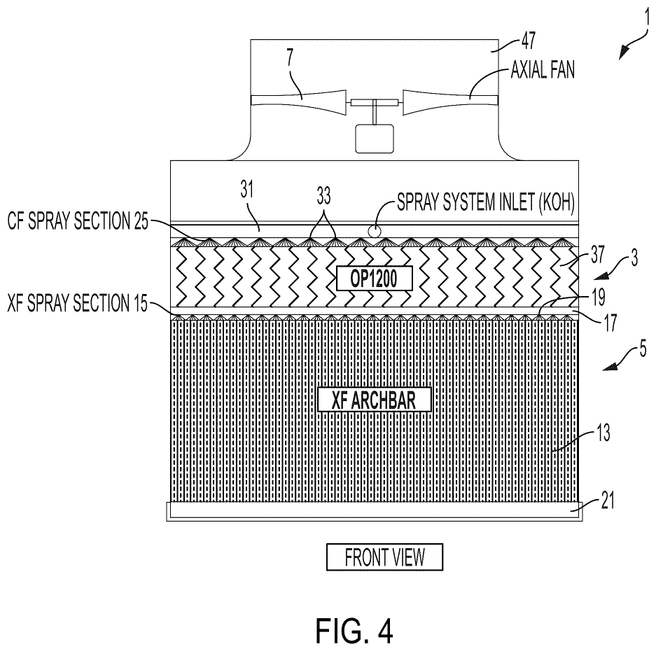

A first example of a contactor as may be used according to the invention is shown in FIGS. 3 and 4. Contactor 1 features a reaction unit 3 centrally located and flanked by saltwater humidifiers 5. A fan 7 or other air mover is situated atop the reaction unit 3 to draw air through air inlets 4 in the side of the humidifiers 5 via air inlet louvers 9 and into the plenum 11.

The humidifiers 5 are provided with splash fill 13, and a saltwater distribution system 15 is located above the splash fill 13. The salt water distribution system 15 includes salt water header 17 and salt water spray nozzles 19, although any type of distribution system may be used. The bottom of the humidifiers 5 features a salt water basin 21 where the salt water distributed by the salt water distribution system 15 collects and is then pumped back to the salt water distribution system with salt water pump 23.

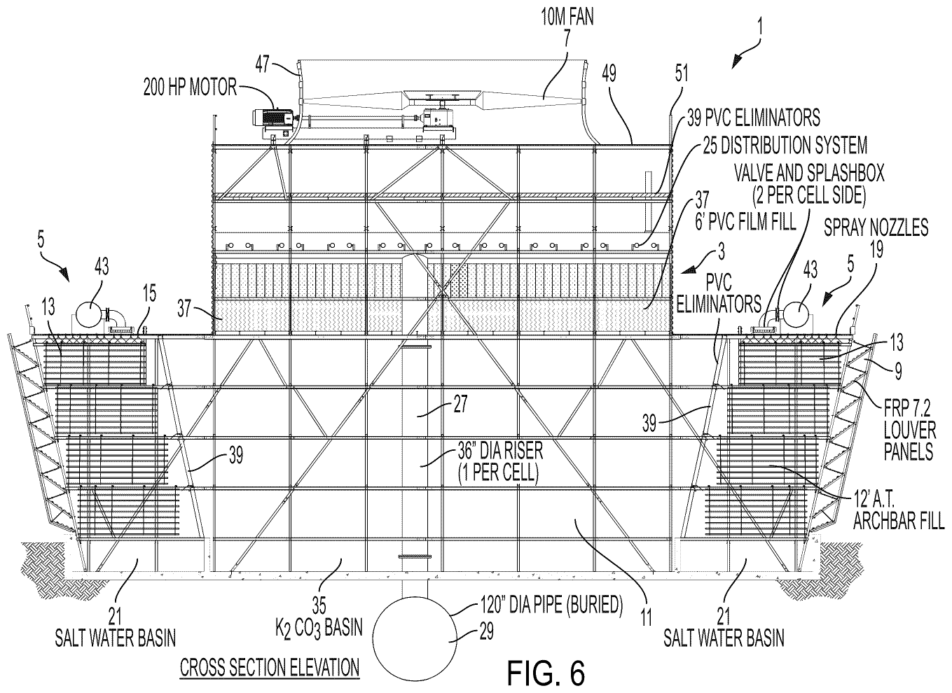

The reaction unit 3 includes plenum 11, which is laterally adjacent to the flanking humidifiers 5, over top which is situated a section of dense/film fill 37. A reaction fluid distribution system 25 is located above the section of dense fill 37 for distributing a reaction fluid over the dense fill. The reaction fluid is preferably sodium hydroxide or potassium hydroxide. The reaction fluid distribution system 25 includes header 31 and spray nozzles 33. The reaction fluid distribution system is fed by riser 27 from feed pipe 29 (See, e.g., FIG. 6).

The fan 7 draws air through the splash fill 13 in the humidifier sections 5 as the fill is wetted by the salt water distribution system 15; the air drawn by the fan then passes into the plenum 11 and up through the dense fill 37 that is wetted by the reaction fluid distribution system 25 and out the top of the device. When the ambient air, humidified by the humidifiers 5, contacts the reaction fluid in the dense fill section of the reaction unit 3, a chemical reaction causes a mass transfer of carbon dioxide in the air to bond with the potassium or sodium to form potassium carbonate or sodium carbonate and water. The resulting potassium carbonate or sodium carbonate and any unreacted reaction fluid falls into the central basin 35 for further processing or disposal. Drift eliminators 39 are situated between the splash fill 13 of the humidifiers 5 and the plenum 11 as well as above the reaction fluid distribution system 25.

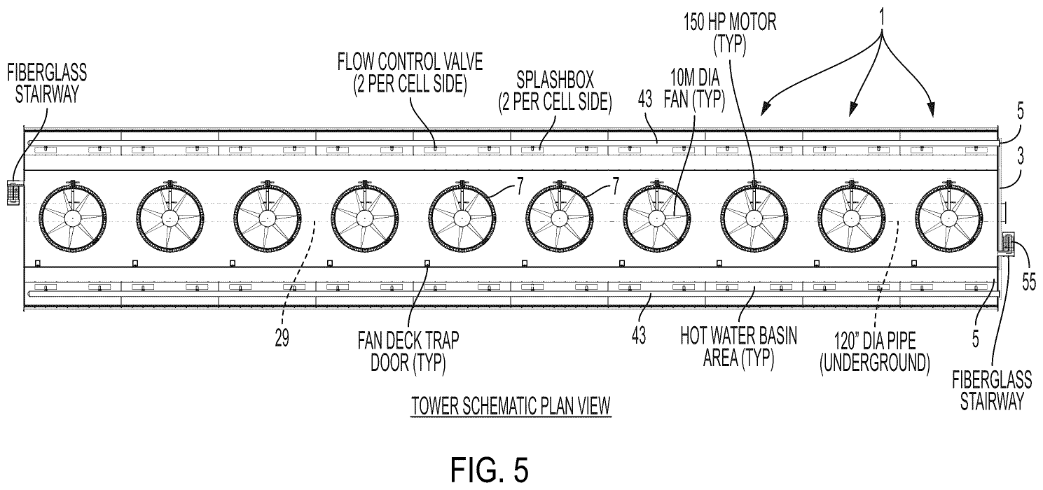

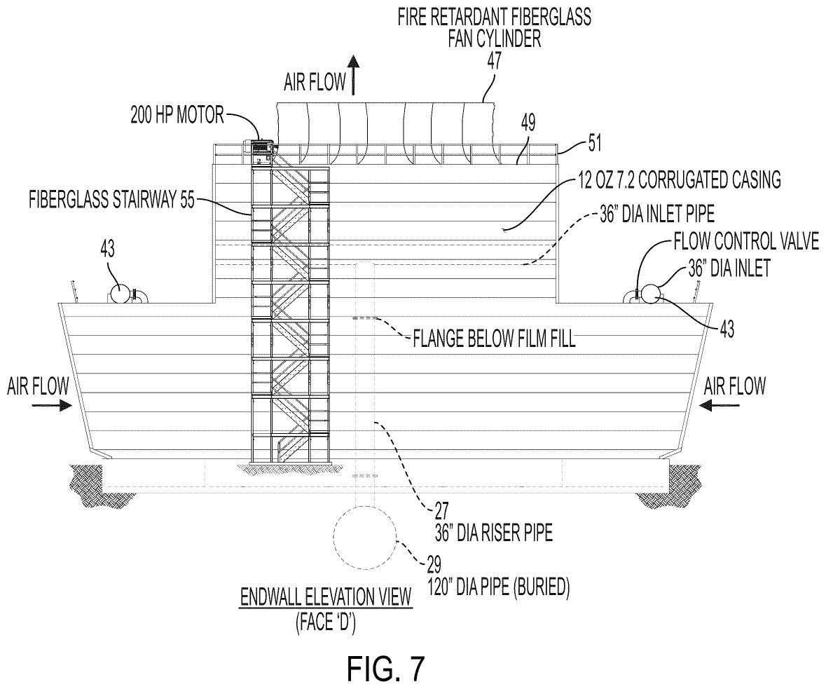

The contactor device shown in FIGS. 3 and 4 is an individual module or “cell” containing a single reaction unit, which may be used standalone, or together with a plurality of other cells, according to the embodiment shown in FIGS. 5 through 7. According to the embodiment of FIGS. 5 through 7, the salt water basins 21 and the reaction fluid basin 35 each run the length of the plurality of cells. Additionally, a salt water supply pipe 43 runs along the top of each humidifier section providing salt water to the salt water distribution systems 15 of each cell. A reaction fluid supply pipe 29 is buried beneath the longitudinal axis of the center basin 35, and feeds reaction fluid to the reaction fluid distribution system 25 via riser 27. As shown in FIG. 5, the fan 7 is enclosed by a fan cylinder or shroud 47, the fan deck 49 is enclosed with a safety railing 51, the outside of the unit is clad in corrugated casing 51, and a stairway 55 may be provided to permit service access to the top of the unit.

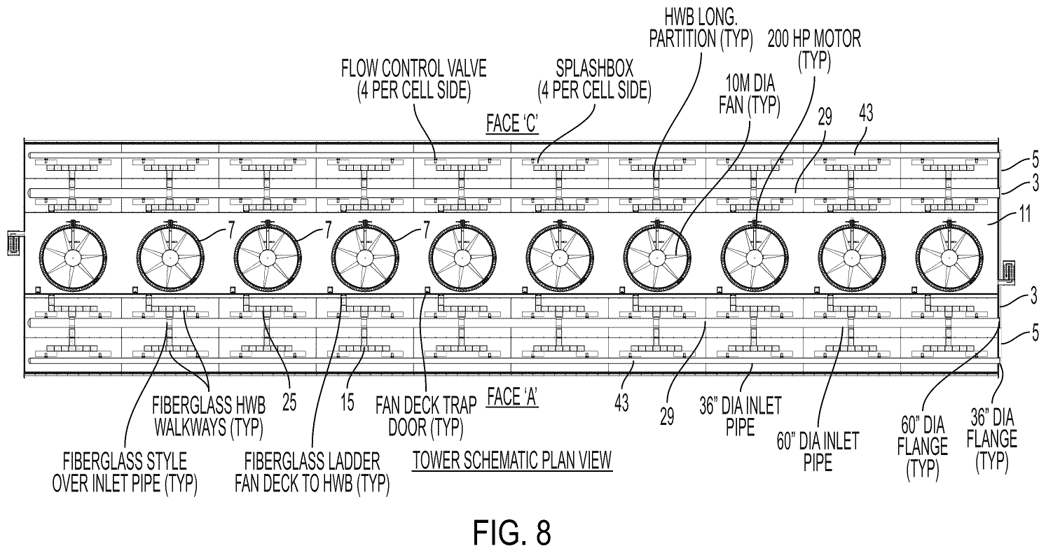

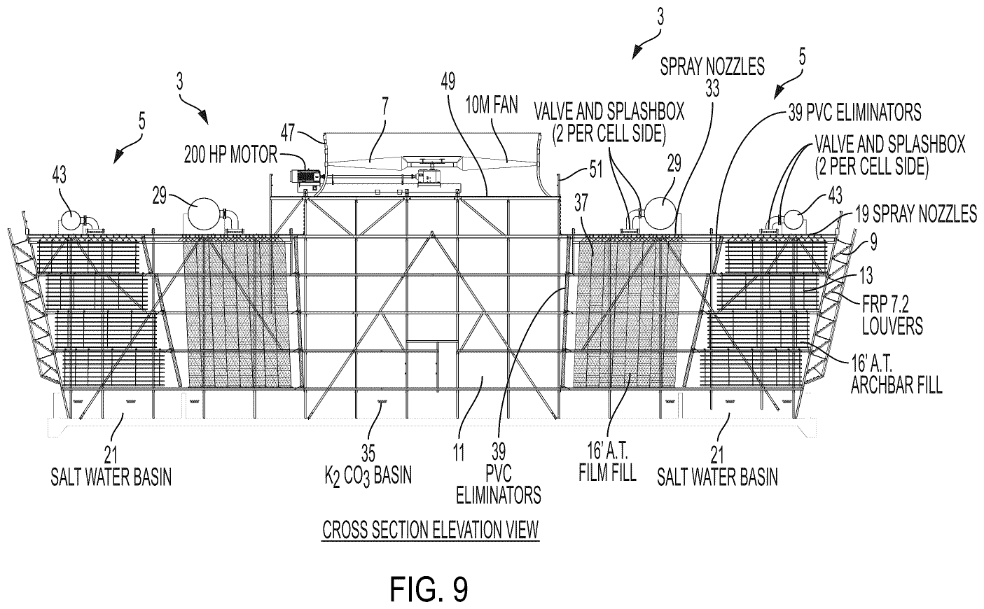

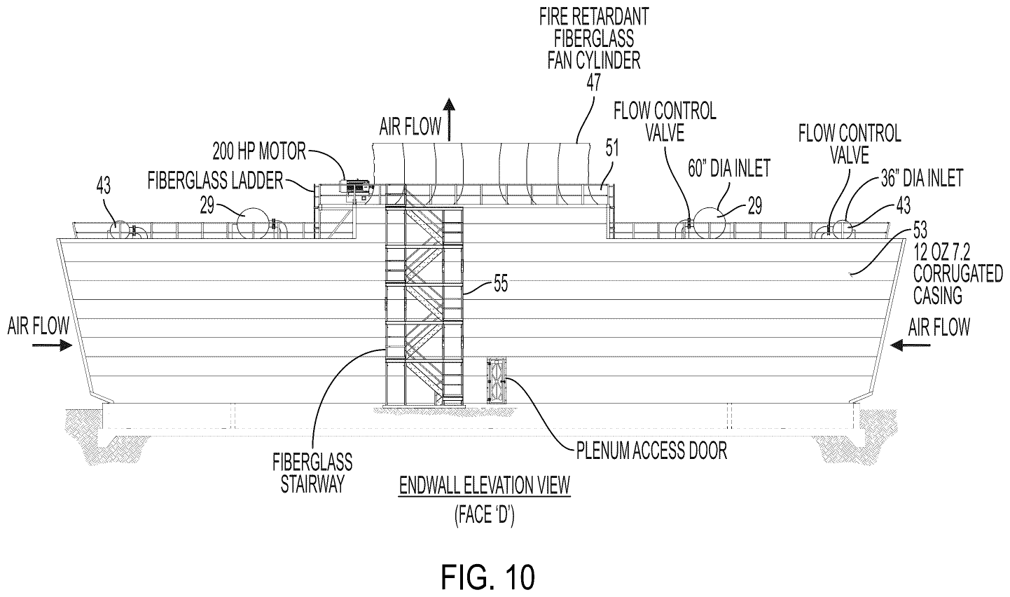

FIGS. 8 through 10 show another example of a contactor which may be used according to the invention in which the reaction unit 3 of each cell is provided laterally between the plenum 11 and the humidifiers 5, rather than above the plenum 11 and directly below the fan 7 as shown in FIGS. 3-7. According to this type of contactor, an elongated reaction fluid basin 35 is flanked by two elongated salt water basins 21. The plena 11 of a plurality of carbon capture cells are centered over the longitudinal axis of the reaction fluid basin. According to a preferred embodiment, the plena 11 of a plurality of cells are separated by a partition wall between each cell. Two reaction units 3 flank each plenum 11 and are located above lateral sections of the reaction fluid basin 35. A reaction fluid supply pipe 29 runs along the top of each row of reaction units 3 and provides reaction fluid to the reaction fluid distribution system 25 of each reaction unit. A salt water supply pipe 43 runs along the top of each humidifier section 5 providing salt water to the salt water distribution systems 15 of each cell.

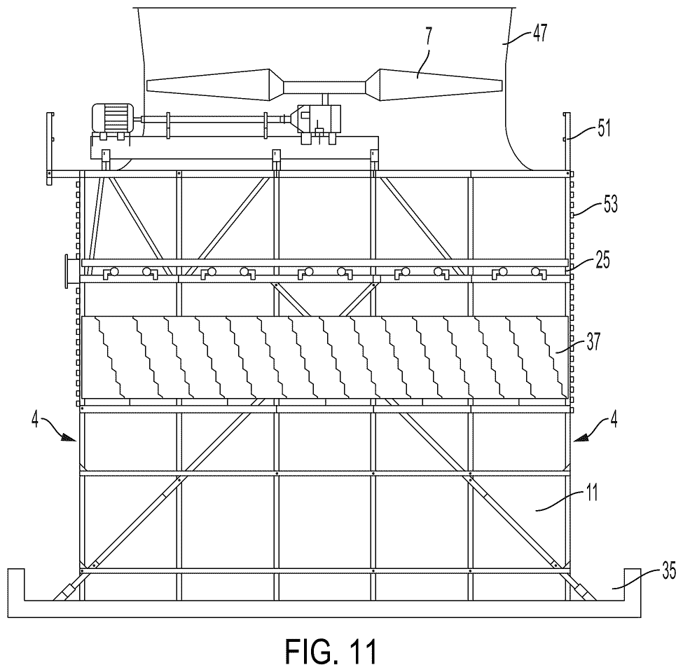

FIG. 11 shows an type of contactor that may be used according to the invention for use in locations where humidifiers are not necessary due to the normal humidity of the ambient air or where humidifiers are not economical due to a lack of water. According to this type of contactor, no humidifiers are provided. The fan 7 draws ambient air directly into the plenum 11 of the reaction unit 3 up through a section of dense fill 37 and out the top of the unit. Reaction fluid distribution system 25 distributes the reaction fluid over the fill 37 and the resulting carbonate and unreacted reaction fluid and water fall into the reaction fluid basin 35. Louvers 9 are provided at air inlets 4 to the plenum 11, and cladding or other sheathing is provided around the exterior of the fill section and the fluid distribution section.

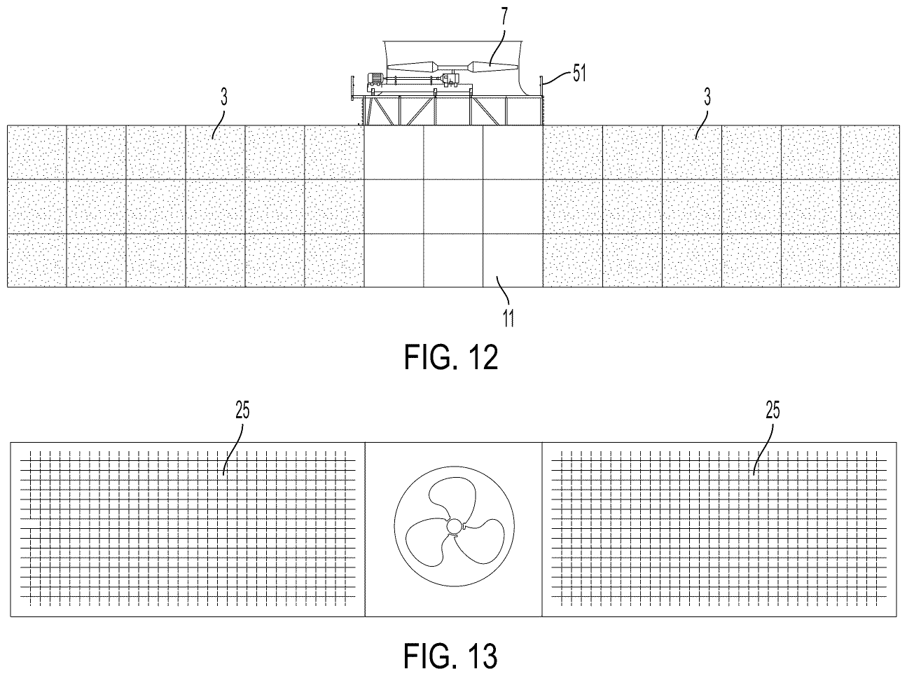

FIGS. 12 and 13 show another example of a contactor that may be used according to the invention (elevation and plan views, respectively) for use in locations where humidifiers are not necessary or not economical due to shortage of water. As with the embodiment of FIG. 11 no humidifiers are provided in the embodiment of FIGS. 12 and 13. Where the reaction unit of FIG. 11 is directly below the fan, the reaction units 3 of the embodiment of FIGS. 12 and 13 flank the plenum 11.

The reaction fluid distribution system 25 is located at the top of the reaction units 3 which are loaded with dense fill 37, and the reaction fluid distribution system 25 distributes reaction fluid over the fill. Ambient air is drawn into and through the reaction units 3, into the plenum 11, and up through the top of the fan 7. The resulting carbonate and unreacted reaction fluid and water fall into the basin below.

The examples of contactors described herein for generating carbonate rich alkaline solution from carbon dioxide in ambient air and carbonate lean alkaline solution are exemplary only and are not intended to limit the type of reaction device used to carry out this reaction.

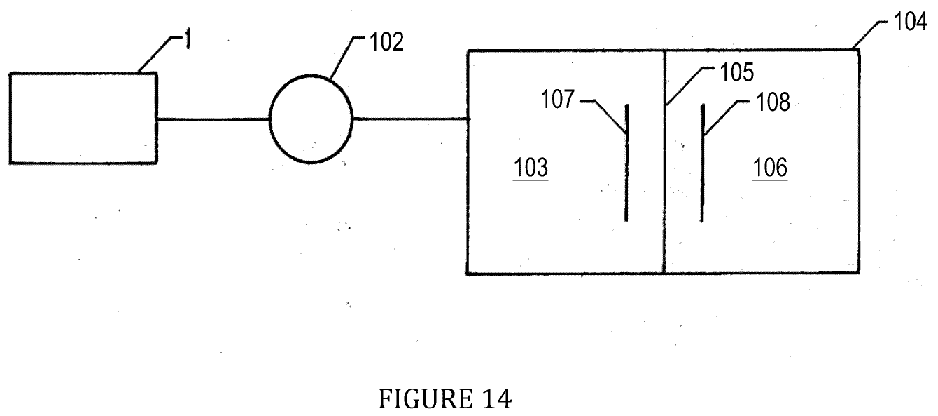

The carbonate rich alkaline solution generated in contactor 1 by reacting carbon dioxide with a carbonate lean alkaline solution is fed to electrolyzer 100 (FIG. 14). The electrolyzer used according to the invention may be any electrolyzer that that uses a carbonate rich alkaline solution to regenerate a carbonate lean alkaline solution, releasing hydrogen, oxygen and carbon dioxide.

The feed is introduced into anodic compartment 103 of electrolytic cell 104. The feed can be introduced by pump 102, which can be a metering pump.

The electrolytic cell contains a cation permselective membrane 105. Cation permselective membranes contain exchange groups on homogeneous or heterogeneous sheets. These exchange groups may be acidic groups, such as sulphonic, carboxylic phosphonic, or other groups which exhibit cation exchange properties, including membranes which contain perfluorosulfonic acid groups as the cation exchange groups. The cation permselective membranes are generally inert to the electrolytic process conditions. Other membranes can also be used. For example, membranes containing carbon-hydrogen bonds instead of carbon-fluorine bonds can be used in the practice of the invention. Any electrolysis membrane can be used.

The anodic compartment of the electrolytic cell is provided with an anode 107, preferably a dimensionally stable anode such as a “DSA”-brand anode or a platinum-iridium anode. Other oxygen evolving electrodes may be used as the anode. Cathode 108 can be, for example, a nickel or steel cathode. The electrolytic cell normally is equipped with a platinum-iridium anode or other O₂ evolving anode and a parallel plate nickel cathode.

The anolyte temperature is maintained at temperatures greater than ambient temperatures throughout the process of the invention. Generally, the temperature of the anolyte is maintained at about 90° C. The elevated temperature of the anolyte may depend on the concentration of alkali metal bicarbonate in the feed, and the boiling point of the feed solution. Preferably the temperature of the anolyte is at or near the boiling point of the feed solution. The contents of anodic compartment can be maintained at elevated temperatures, by conventional means, e.g., a heater.

When a standard electrolytic cell is utilized, a current is passed between the anode and cathode which are separated by the permselective membrane. In the anode compartment is an aqueous solution of sodium carbonate and/or bicarbonate. Water is electrolyzed at the anode surface to yield oxygen gas and hydrogen ion which then reacts with the carbonate ion present in the anolyte to yield bicarbonate ion, which in turn reacts with more hydrogen ion to yield carbonic acid, which breaks down into water and carbon dioxide.

Thus, in the anolyte compartment, oxygen gas and carbon dioxide gas are given off and the anolyte is constantly renewed with a new supply of sodium carbonate and/or sodium bicarbonate solution.

At the cathode, water is likewise electrolyzed yielding hydrogen gas and hydroxyl ions. The sodium ions from the anolyte compartment are attracted by the cathode and passed through the permselective membrane and react in the catholyte compartment with the generated hydroxyl ions to yield a caustic solution which is continuously or intermittently withdrawn. Makeup water is required in the catholyte chamber and is supplied as required.

Both the anode and cathode compartments operate with an alkaline pH, usually about 8-14.

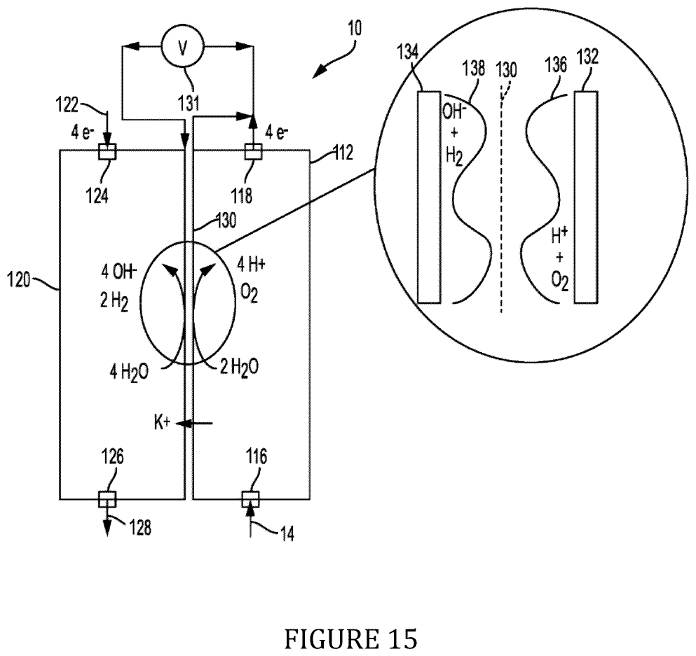

FIG. 15 shows another embodiment of an electrolyzer 100 that may be used according to the invention in a system to remove carbon dioxide from the environment while generating hydrogen gas (H₂) for power generation. In operation, a voltage is applied by a voltage source 131 to electrodes 132 and 134 on either side of a membrane 130. The electrolyzer has a first chamber 112 that receives a flow of an input solution 114 at valve 116 from contactor 1. The first chamber generates H+ ions due to the electrolysis of water. This causes the input solution to become acidified before exiting the chamber as an initial output solution through valve 118.

The electrolyzer has an ion-selective membrane 130, such as a cation exchange membrane, that separates the electrolyzer into the first chamber 112 and the second chamber 120 but allows for exchange of ions. The second chamber 120 receives a return flow 122 at a valve 124 and produces an output flow 128 through valve 126. If the electrolyzer is the return electrolyzer in the series, its input solution consists of the solution after removal of carbon dioxide by the carbon dioxide removal unit operation. The carbon dioxide-poor output solution 128 has become ‘basified’ as it passes through the second chamber, in that its pH is higher, even if it would be considered acidic based upon its pH.

This integrated process removes carbon dioxide from the air and generates hydrogen gas. The hydrogen gas is preferably provided directly to an on-site power plant for power generation. The hydrogen may be used alone in a hydrogen gas powered turbine power plant or blended together with natural gas or ammonia. In any case, power generated by the power plant is used to provide power to the contactor, the electrolyzer, and/or any accessory devices, including an ammonia production facility.

It is understood that various other modifications will be apparent to and can readily be made by those skilled in the art without departing from the spirit and scope of this invention. Accordingly, it is not intended that the scope of the claims appended hereto be limited to the description set forth herein but rather that the claims be construed as encompassing all the features of patentable novelty which reside in the present invention including all features which would be treated as equivalents thereof by those skilled in the art to which the invention pertains.

1. An apparatus for clean power generation comprising:
a. a carbon contactor configured to remove carbon dioxide from ambient air by contacting with a carbonate lean alkaline solution to produce a carbonate rich alkaline solution,
b. an electrolyzer located and configured to receive said carbonate rich alkaline solution from said carbon contactor and generate hydrogen gas and said carbonate lean alkaline solution,
c. a gas turbine power plant located and configured to receive said hydrogen gas from said electrolyzer and configured to provide power to said carbon contactor and said electrolyzer,
d. an alkaline solution recirculation system configured and located to recycle said carbonate lean alkaline solution to said carbon contactor from said electrolyzer.

2. The apparatus according to claim 1, wherein said gas-turbine power plant is powered by pure hydrogen gas.

3. The apparatus according to claim 1, wherein said gas-turbine power plant is powered by a blend of hydrogen gas and natural gas.

4. The apparatus according to claim 1, wherein said gas turbine power plant is powered by a blend of hydrogen gas and ammonia.

5. The apparatus according to claim 1, further comprising an ammonia production facility located and configured to provide ammonia to said gas turbine power plant.
